(19) United States
(12) Patent Application Publication
(10) Pub. No.: US 2022/0180741 A1
(43) Pub. Date: Jun. 9, 2022

(54) METHOD, APPARATUS AND COMPUTER PROGRAM PRODUCT FOR DETECTING A LANE CLOSURE USING PROBE DATA

(71) Applicant: HERE GLOBAL B.V., Eindhoven (NL)

(72) Inventor: James Adeyemi Fowe, Evanston, IL (US)

(73) Assignee: HERE GLOBAL B.V., Eindhoven (NL)

(21) Appl. No.: 17/115,999

(22) Filed: Dec. 9, 2020

(51) Int. Cl. G08G 1/056; G08G 1/01

(52) U.S. Cl. CPC G08G 1/056; G08G 1/0129

(57) ABSTRACT

A method, apparatus and computer program product are provided to determine lane statuses such as closures and/or shifting, by using probe data, such as probe data collected from vehicle and/or mobile devices traveling along a road segment. Probe data collected in real-time or near real-time is compared to historical probe data to determine differences in lateral positional indicators of vehicles along a route. The determined lane status may further include a direction of lane shift or lateral offset, indicator of which lane is closed, and/or shifted, and/or an indication of a lane associated with a leftmost and/or rightmost shift, and an indication of a lane associated with the largest shift. Notifications of detected lane statuses may be provided to drivers and/or other systems or users.

### TECHNOLOGICAL FIELD

An example embodiment relates generally to a method, apparatus and computer program product for detecting lane statuses of road segments, such as a lane closures or shifting, using probe data.

### BACKGROUND

Some traffic-aware routing and navigation systems detect road closure events or slowdowns caused by accidents, road construction, and/or the like by detecting the thru traffic in road segments. Such systems detect average speeds of traffic moving through a particular segment, and provide alerts relating to slowdowns when average speeds of traffic stop or differ substantially from average or normal traffic speeds for the same segment at the same time of day or time of week. In some instances, the alert may include a general cause of the slowdown, such as road construction or accident, and may provide a time estimate of additional time it will take to travel through the segment, in comparison to average or normal traffic conditions.

In many cases, information related to the general cause of slowdowns, such as construction or an accident, is provided to a service from another user who has passed through the area, or may be generated from integrated accident reporting systems, road construction reporting systems, and/or the like.

The information or alerts provided to drivers using such systems may be helpful for determining general traffic speeds for the segment, but may not provide details pertaining to lane-level information. For example, in instances in which a road segment includes a plurality of lanes, the segment information is oftentimes not specific as to individual lanes nor the side of the road, or side of the road segment affected. Even if information regarding lane closure or shoulder closure is provided, such systems rely on user input, such as by another driver, or an administrator or customer service representative associated with construction activities, accident responses, and/or the like, to provide the lane-level details to a system prior to dissemination to drivers. In many cases the information may be outdated, inaccurate, and/or not provided in a timely and efficient manner to alert drivers.

### BRIEF SUMMARY

A method, apparatus and computer program product are provided in accordance with an example embodiment to provide lane statuses, such as but not limited to lane closures, and/or shifting, determined based on probe data. Accordingly, more detailed lane-level information, as opposed to segment-level traffic information only, are provided. The method, apparatus and computer program product of an example embodiment utilize probe data collected in real-time or near real-time, and compare the probe data to historical probe data to estimate changes in lateral positioning of vehicle probes relative to the segment, or across a segment. Example embodiments may therefore determine a lane status including an indicator that a lane is closed or shifted. A lane status may also include a direction of lane shift or lateral offset, an indication of a lane associated with a leftmost and/or rightmost shift, an indication of a lane associated with the largest shift, and/or the like.

An apparatus is provided including at least processing circuitry and at least one non-transitory memory including computer program code instructions, the computer program code instructions configured to, when executed by the processing circuitry, cause the apparatus to partition subject probe data associated with at least one segment into a same number of clusters as historical probe data associated with the at least one segment, wherein the historical probe data is clustered based on respective lateral positional indicators. The at least one memory further includes computer program code instructions to cause the apparatus to, for each cluster of the subject probe data, compare a statistical measure of the subject lateral positional indicators to respective statistical measures of the historical lateral positional indicators. The at least one memory further includes computer program code instructions to cause the apparatus to, determine whether any lane of the at least one segment is closed dependent upon the comparison of the statistical measure of the subject lateral positional indicators to the respective statistical measure of the historical lateral positional indicators.

In an instance at least one statistical measure of the subject lateral positional indicator differs from the respective statistical measure of the historical lateral positional indicator by either of (a) at least a closure threshold, or (b) an amount greater than the closure threshold, the computer program code instructions are further configured to cause the apparatus to determine that at least one lane of the at least one segment is closed. In an instance it is determined no lanes of the at least one segment are closed, the computer program code instructions are further configured to cause the apparatus to determine whether at least one lane of the at least one segment is shifted.

The at least one memory further includes computer program code instructions to cause the apparatus to, in an instance at least one lane of the at least one segment is determined as closed, determine a direction of lateral offset of at least one statistical measure of the subject lateral positional indicators relative to the respective statistical measure of the historical lateral positional indicators, and identify at least one closed lane based upon the direction of the lateral offset.

In certain embodiments, determining whether any lane of the at least one segment is closed is performed in real-time or near real-time relative to the receipt of the subject probe data.

The subject probe data may be associated with a time relative to a week or a day of the week, and the historical probe data is associated with the same time period relative to at least one prior week or at least one prior day of the week.

According to certain embodiments, the at least one memory further includes computer program code instructions to cause the apparatus to perform a k-means algorithm on the historical probe data to partition the historical probe data and determine the clusters of the historical probe data, and determine the respective statistical measures of the historical lateral positional indicators.

A computer program product is also provided, including at least one non-transitory computer-readable storage medium having computer-executable program code instructions stored therein, the computer-executable program code instructions comprising program code instructions to partition subject probe data associated with at least one segment into a same number of clusters as historical probe data associated with the at least one segment, wherein the historical probe data is clustered based on respective lateral positional indicators.

The computer-executable program code instructions further include program code instructions to, for each cluster of the subject probe data, compare a statistical measure of the subject lateral positional indicators to respective statistical measures of the historical lateral positional indicators. The computer-executable program code instructions further include program code instructions to determine whether any lane of the at least one segment is closed dependent upon the comparison of the statistical measure of the subject lateral positional indicators to the respective statistical measure of the historical lateral positional indicators.

In certain embodiments, the computer-executable program code instructions further include program code instructions to, in an instance at least one statistical measure of the subject lateral positional indicator differs from the respective statistical measure of the historical lateral positional indicator by either of (a) at least a closure threshold, or (b) an amount greater than the closure threshold, determine that at least one lane of the at least one segment is closed.

In an instance it is determined no lanes of the at least one segment are closed, the computer-executable program code instructions further include program code instructions to determine whether at least one lane of the at least one segment is shifted.

In an instance at least one lane of the at least one segment is determined as closed, the computer-executable program code instructions further include program code instructions to determine a direction of lateral offset of at least one statistical measure of the subject lateral positional indicators relative to the respective statistical measure of the historical lateral positional indicators and to identify at least one closed lane based upon the direction of the lateral offset.

In certain embodiments, the computer-executable program code instructions further comprise program code instructions to perform a k-means algorithm on the historical probe data to partition the historical probe data and determine the clusters of the historical probe data, and determine the respective statistical measures of the historical lateral positional indicators.

A method is provided, including partitioning subject probe data associated with at least one segment into a same number of clusters as historical probe data associated with the at least one segment, wherein the historical probe data is clustered based on respective lateral positional indicators. The method further includes, for each cluster of the subject probe data, comparing a statistical measure of the subject lateral positional indicators to respective statistical measures of the historical lateral positional indicators, and determining whether any lane of the at least one segment is closed dependent upon the comparison of the statistical measure of the subject lateral positional indicators to the respective statistical measure of the historical lateral positional indicators.

The method may further include, in an instance at least one statistical measure of the subject lateral positional indicator differs from the respective statistical measure of the historical lateral positional indicator by either of (a) at least a closure threshold, or (b) an amount greater than the closure threshold, determining that at least one lane of the at least one segment is closed.

The method may further include, in an instance it is determined no lanes of the at least one segment are closed, determining whether at least one lane of the at least one segment is shifted.

In an instance at least one lane of the at least one segment is determined as closed, the method may include determining a direction of lateral offset of at least one statistical measure of the subject lateral positional indicators relative to the respective statistical measure of the historical lateral positional indicators, and identifying at least one closed lane based upon the direction of the lateral offset.

The method may further include performing a k-means algorithm on the historical probe data to partition the historical probe data and determine the clusters of the historical probe data, and determining the respective statistical measures of the historical lateral positional indicators.

An apparatus is provided, with means for partitioning subject probe data associated with at least one segment into a same number of clusters as historical probe data associated with the at least one segment, wherein the historical probe data is clustered based on respective lateral positional indicators. The apparatus further includes means, for each cluster of the subject probe data, for comparing a statistical measure of the subject lateral positional indicators to respective statistical measures of the historical lateral positional indicators. The apparatus further includes means for determining whether any lane of the at least one segment is closed dependent upon the comparison of the statistical measure of the subject lateral positional indicators to the respective statistical measure of the historical lateral positional indicators.

The apparatus may further include, in an instance at least one statistical measure of the subject lateral positional indicator differs from the respective statistical measure of the historical lateral positional indicator by either of (a) at least a closure threshold, or (b) an amount greater than the closure threshold, means for determining that at least one lane of the at least one segment is closed.

In certain embodiments, the apparatus includes, in an instance it is determined no lanes of the at least one segment are closed, means for determining whether at least one lane of the at least one segment is shifted.

In certain embodiments, the apparatus includes, in an instance at least one lane of the at least one segment is determined as closed, means for determining a direction of lateral offset of at least one statistical measure of the subject lateral positional indicators relative to the respective statistical measure of the historical lateral positional indicators, and identifying at least one closed lane based upon the direction of the lateral offset.

The apparatus may further include means for performing a k-means algorithm on the historical probe data to partition the historical probe data and determine the clusters of the historical probe data, and means for determining the respective statistical measures of the historical lateral positional indicators.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a system diagram depicting a lane status determination apparatus in data communication with user equipment and a database, in accordance with an example embodiment of the present disclosure;

FIG. 2 is a block diagram illustrating an apparatus that may be configured to detect a lane closure and/or lane shift in accordance with an example embodiment of the present disclosure;

FIG. 3 is a flowchart illustrating operations performed in accordance with an example embodiment of the present disclosure;

FIG. 4 is a schematic of lateral positional indicators of probe data relative to a center line vector in accordance with an example embodiment of the present disclosure;

FIGS. 5 and 6 are plots of lateral positional indicators of probe data in accordance with an example embodiment of the present disclosure;

FIG. 7 is a flowchart illustrating operations performed in accordance with an example embodiment of the present disclosure; and

FIG. 8 is a schematic of a plurality of segments in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

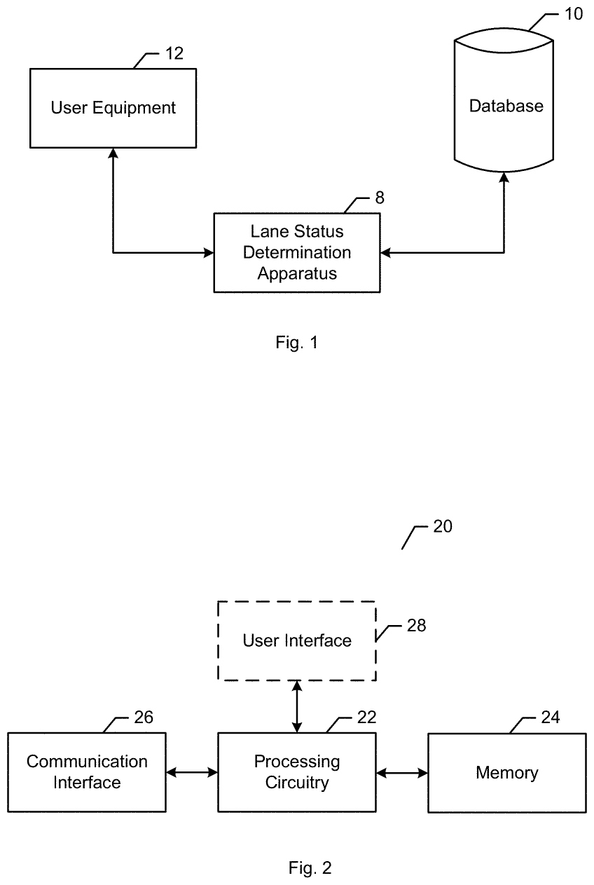

Referring to FIG. 1, an exemplary system in which certain example embodiments operate is depicted. The illustrated embodiment of FIG. 1 includes a lane status determination apparatus 8 in data communication with user equipment (UE) 12 and a database 10. The components of FIG. 1 may communicate over a network that may be wired, wireless, or any combination of wired and wireless communication networks, such as cellular, Wi-Fi, internet, local area networks, or the like In general, probe data, such as vehicle probe data, collected from probe devices is collected and stored in database 10. In this regard, any of a variety of devices may serve as a probe device, such as a mobile device, (e.g., a smartphone, a tablet computer, a personal digital assistant (PDA), a personal navigation device (PND), or the like), an in-vehicle navigation system, a vehicle control system, an ADAS or the like, that provides samples of probe data regarding, for example, the location of a vehicle as the vehicle proceeds along a road. The probe data may include not only the location of the vehicle as may be defined by a global positioning system (GPS) associated with the probe, and the time (e.g., timestamp, time of day, and/or time of week) at which the vehicle is at the location, but also the speed, the heading and other parameters that define the current behavior of the vehicle.

In certain embodiments, the database 10 may be populated and maintained by a separate service accessible by lane status determination apparatus 8 and may further include a map database and/or map data. While database 10 is illustrated as a single database in FIG. 1, it will be appreciated that in certain embodiments, a map database may be implemented separately from a database storing the probe data, and the probe data may include any location-based data that enables association with a road segment, or segment, defined by a map database, such as via a map matching technique described in further detail below.

The map data, such as the map data stored on database 10, may be maintained by a content provider such as a map developer. By way of example, the map developer can collect geographic data to generate and enhance the database 10. There can be different methods used by the map developer to collect data. These methods can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used to generate map geometries directly or through machine learning.

The database 10 may include a master map database stored in a format that facilitates updating, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by user equipment 12, for example. Further, data may be compiled defining segments of the map database.

The compilation to produce the end user database(s) can be performed by a party or entity separate from the lane status determination apparatus 8. For example, a navigation device developer or other end user device developer, can perform compilation on a received map database and/or probe database in a delivery format to produce one or more compiled databases. For example, as discussed herein, probe data may be map matched to segments defined in the map database. Example embodiments, such as lane status determination apparatus 8 may therefore access and utilize historical probe data that is map matched to a segment. However, in certain embodiments lane status determination apparatus 8 may perform a map matching technique to match probe data to a segment and utilize the matched data as described in further detail herein.

As mentioned above, the database 10 may include a master geographic database, but in certain embodiments, the database 10 may represent a compiled navigation database that may be used in or with end user devices (e.g., user equipment 12) to provide navigation and/or map-related functions. For example, the database 10 may be used with the user equipment 12 to provide an end user with navigation features. In such a case, the database 10 can be downloaded or stored on the end user device (user equipment 12) which can access the database 10 through a wireless or wired connection, such as via the lane status determination apparatus 8, for example.

In an example embodiment, the map data may include node data, road segment data or link data, point of interest (POI) data or the like. The database may also include cartographic data, routing data, and/or maneuvering data. According to some example embodiments, the road segment data records may be segments or segments representing roads, streets, or paths, as may be used in calculating a route or recorded route information for determination of one or more personalized routes. The map data may include various attributes of road segments and/or may be representative of sidewalks or other types of pedestrian segments, as well as open areas, such as grassy regions or plazas. The node data may be end points corresponding to the respective links and/or segments. The segment data and the node data may represent a road network, such as used by vehicles, cars, trucks, buses, motorcycles, and/or other entities. Optionally, the database may contain path segments and node data records or other data that may represent bicycle lanes, pedestrian paths or areas in addition to or instead of the vehicle road record data, for example. The segment and nodes can be associated with attributes, such as geographic coordinates, street names, address ranges, speed limits, turn restrictions at intersections, direction of travel, and/or other navigation-related attributes, as well as POIs, such as fueling stations, hotels, restaurants, museums, stadiums, offices, auto repair shops, buildings, stores, parks, etc. The database can include data about the POIs and their respective locations in the POI records. The database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database. The map database may further indicate a plurality of contiguous segments as a strand. It will be appreciated that some references made herein to a single segment may refer to a strand comprising multiple segments. Accordingly, resultant data may be generated that is associated with a strand, or a plurality of contiguous segments.

According to example embodiments, the map data is utilized in a manner that enables probe data to be associated with a segment. In addition to, or alternatively to the probe data including location data, such as GPS location, the probe data may also include an identifier, such as a trajectory identifier, that identifies the probe that provides the probe data and enables the linking of instances of probe data into vehicle trajectories and probe traces while still, in some embodiments, maintaining the anonymity of the probe device and/or a vehicle that the probe device is onboard. Thus, probe traces define the path of a probe device, such as may be carried by a vehicle during its travel along a portion of the road network.

As such, example embodiments may collect subject probe data associated with a segment and compare positional information to that of historical probe data for the same segment. The data may be compared in real-time or near real-time such that alerts regarding lane statuses, including but not limited to closed, and/or shifted lanes, may be provided to drivers traveling in or approaching the affected segment. The alerts may be provided to any user equipment 12 such as a navigation system, an advanced driver assistance system (ADAS), an in-vehicle infotainment system, a mobile device (such as one configured to access a mapping or navigation application or website), a dynamic road sign, a personal navigation device (PND), a portable navigation device, a cellular telephone, a smart phone, a personal digital assistant (PDA), a watch, a camera, a computer, and/or other device. In certain embodiments, the user equipment 12 may include a mobile device associated, coupled, or otherwise integrated with a vehicle, such as in a vehicle's head unit, infotainment unit, navigation system, or an ADAS, for example. In certain embodiments, the user equipment 12 configured to provide alerts and navigational-related information may embody a same probe device that transmits probe data over the network for processing as described herein.

As used herein, the terms real-time and near real-time indicate a seemingly instant accounting of probe data associated with a segment for a given time period leading up to a present or current time. Additionally or alternatively, a response to a request described herein may be provided in real-time or near real-time at the user equipment 12 such that the response time is seemingly instant relative to when the request was made or initiated. For example, a vehicle approaching a segment, may trigger a request for lane-level information for the segment, and example embodiments may utilize real-time or near real-time subject probe data of other vehicles traveling on the segment (in a period of time leading up to a current time) to assess current (e.g., real-time or near real-time) lane statuses, and provide a response in real-time or near real-time to user equipment 12. It will be appreciated that despite references to current, real-time, or near real-time, certain delays based on computer processing time may be encountered. Performing certain operations described herein in real-time or near real-time may enable accurate lane statuses and alerts to be provided in a timely manner to drivers and/or vehicles, such as those approaching a segment with a closed, and/or shifted lane.

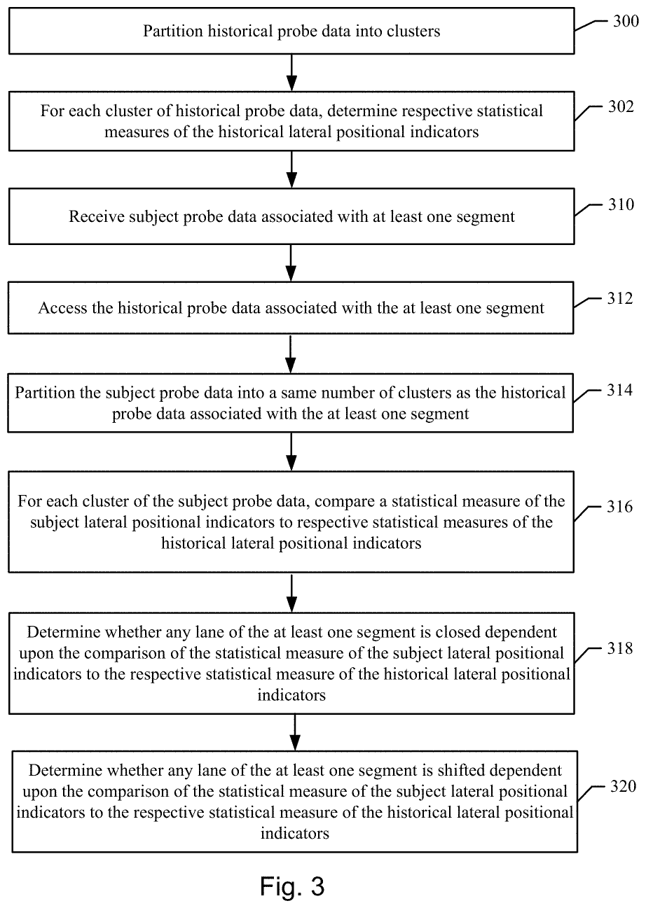

As shown in FIG. 2, an apparatus 20 is provided in accordance with an example embodiment, for implementing the lane status determination apparatus 8 and/or user equipment 12. The apparatus of certain embodiments, such as the lane status determination apparatus 8, may be embodied by any of a wide variety of different computing devices including, for example, a server, a computer workstation, a personal computer, a desktop computer or any of a wide variety of computing devices. In certain embodiments, the user equipment 12 may be embodied by a wide variety of computing devices including, but not limited to, mobile devices, in-vehicle navigation systems, other navigation systems, in-vehicle infotainment systems, dynamic road signs, personal computers, and/or the like. Regardless of the type of computing device that embodies the apparatus 20, the apparatus of an example embodiment includes, is associated with or is in communication with processing circuitry 22, memory 24 and communication interface 26. A user interface 28 is included in apparatus 20 when the apparatus is embodied by user equipment 12, but may be optional when apparatus 20 is embodied by a lane status determination apparatus 8.

In some embodiments, the processing circuitry 22 (and/or co-processors or any other processors assisting or otherwise associated with the processing circuitry) may be in communication with the memory device 24 via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processing circuitry.

The processing circuitry 22 may be embodied in a variety of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processor may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 22 may be configured to execute instructions stored in the memory device 24 or otherwise accessible to the processing circuitry. Alternatively or additionally, the processing circuitry may be configured to execute hard coded functionality. As such, whether configured by hardware or software methods, or by a combination thereof, the processing circuitry may represent an entity (for example, physically embodied in circuitry) capable of performing operations according to an embodiment of the present invention while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of software instructions, the instructions may specifically configure the processing circuitry to perform the algorithms and/or operations described herein when the instructions are executed. However, in some cases, the processing circuitry may be a processor of a specific device (for example, a computing device) configured to employ an embodiment of the present invention by further configuration of the processor by instructions for performing the algorithms and/or operations described herein. The processing circuitry may include, among other things, a clock, an arithmetic logic unit (ALU) and logic gates configured to support operation of the processing circuitry.

The apparatus 20 of an example embodiment may also optionally include a communication interface 26 that may be any means such as a device or circuitry embodied in either hardware or a combination of hardware and software that is configured to receive and/or transmit data from/to other electronic devices in communication with the apparatus, such as any of the components of FIG. 1. Additionally or alternatively, the communication interface may be configured to communicate in accordance with various wireless protocols including Global System for Mobile Communications (GSM), such as but not limited to Long Term Evolution (LTE). In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In this regard, the communications interface 26 may facilitate the collection of, and/or access to, probe data, and access to map data.

The apparatus 20 of an example embodiment, such as user equipment 12, may also optionally include a user interface 28 that provides an audible, visual, mechanical, or other output to the user. As such, the user interface 28 may include, for example, a keyboard, a mouse, a display, a touch screen display, a microphone, a speaker, and/or other input/output mechanisms. As such, in embodiments in which apparatus 20 is implemented as user equipment 12, the user interface 28 may, in some example embodiments, provide means for provision of alerts relating to lane statuses, such as but not limited to closure and/or shifting of a lane. In some example embodiments, aspects of user interface 28 may be limited or the user interface 28 may not be present.

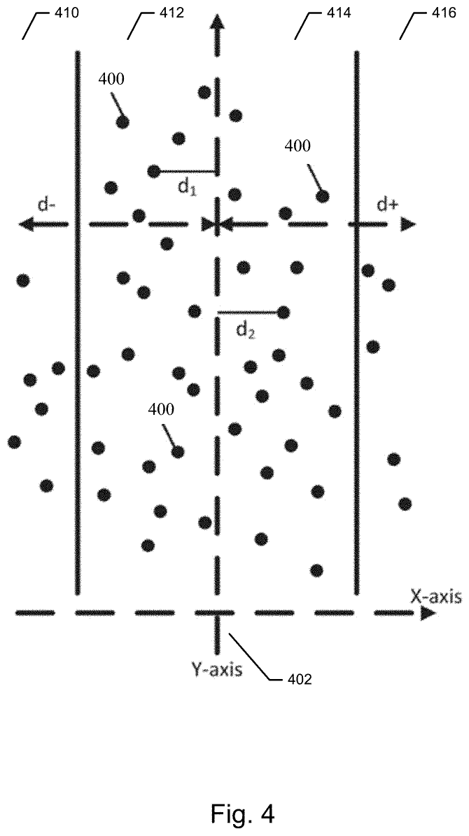

FIG. 3 is a flowchart illustrating example operations of an apparatus 20, according to example embodiments. The operations of FIG. 3 may be performed by apparatus 20, such as with the lane status determination apparatus 8, and/or the like. However, according to certain embodiments, another service or device accessible by the lane status determination apparatus 8 may perform certain operations of FIG. 3, such as operations 300 and 302, such that the operations of FIG. 3 are performed in a distributed system.

As shown in operation 300, apparatus 20 includes means, such as processing circuitry 22, memory 24, communication interface 26, and/or the like, for partitioning historical probe data into clusters based on their lateral positional indicators. Apparatus 20 may access the historical probe data on database 10, over communication interface 26.

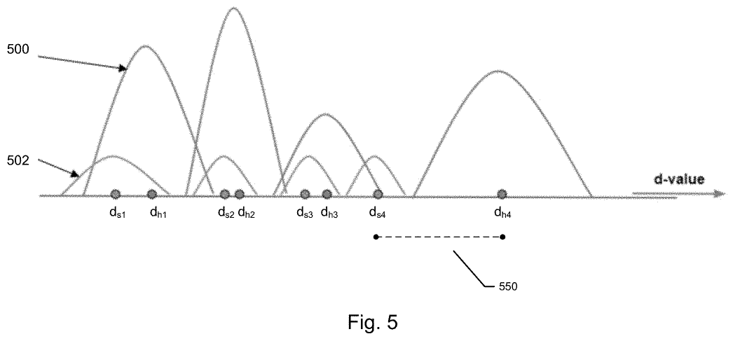

An example of partitioning probe data by lateral positional indicators is illustrated in FIG. 4. A plurality of probe data, or “probes” 400 of a segment are plotted by their deviation or d-value (e.g., d₁ and d₂ in FIG. 4) as the lateral distance, or x-distance between the probe position and a center line vector 402. As illustrated in FIG. 4, the center line vector 402 may be a y-axis vector positioned in the center of a segment, such as by determining a lateral midway point of a spread of the probe data, mean, or median lateral positional indicator of the probe data, and/or the like. A center line vector 402 may additionally or alternatively be identified based on map data and/or any other means. As another example, the center line vector 402 may be determined may be a y-axis vector positioned in the center of an even number of clusters, or a y-axis vector positioned in the center of a center cluster of an odd number of clusters (not shown), and running parallel to the flow of traffic, as indicated by the map matching algorithm and/or trajectories of probe data.

The center line vector 402 is provided herein as an exemplary basis by which to determine a lateral positional indicator, but it will be appreciated that various modifications may be contemplated. For a plurality of probes 400, indicated in FIG. 4 according to the position or location data associated therewith, a center line vector 402 may be generated that represents an estimated center line of a segment.

D-values to the left of the center line vector 402 have negative values and d-values to the right of the center line vector 402 have positive values. The sign or polarity of a positional indicator (e.g., d-value) may indicate direction of the probe from the center line vector 402, and the absolute value of the d-value indicates how far the probe is from the center line vector 402, measured laterally, or at a direction orthogonal to, or substantially orthogonal to the flow of traffic (and/or center line vector 402). As used herein, d-value may refer to the distance from the center line vector 402, but it will be appreciated that the lateral positional indicators may be determined using a different basis than the center line vector 402. A d-value may therefore be considered a lateral positional indicator of the probe. In any event, the d-values may then be used to partition the clusters, such as by using any suitable clustering algorithm, such as k-means.

With regard to performing the k-means algorithm, it will be appreciated that example embodiments, such as processing circuitry 22, may utilize any number of clusters k. As shown in FIG. 4, the k-means algorithm may be performed with k=4 to partition the probe data into four clusters 410, 412, 414 and 416. The value of k need not necessarily be the number of lanes of the segment, but rather may be a value determined as producing accurate results, such as in comparison to utilizing a different k-value producing less accurate results. To assess accuracy of different k-values, a data analyst may study the results of certain samples, according to example embodiments provided herein, and configure or program a k-value. As another example, different k-values may be determined for different segments, or segments having specific characteristics as indicated by the map data. One k-value may be determined for segments having one or more predefined ratings and/or classifications, while a different k-value may be determined for segments having one or more different predefined ratings and/or classifications according to the map data.

Accordingly, in operation 302, apparatus 20 includes means, such as processing circuitry 22, memory 24, and/or the like, for determining statistical measures of the lateral positional indicators for each cluster. For example, a mean d-value and/or standard deviation of d-values may be computed for each cluster. A statistical measure of the lateral positional indicator, such as a mean d-value for each cluster indicates a positioning of that cluster either on the left or right or center of the center line vector 402, and to what extent. The sign or polarity of the statistical measure (e.g., mean d-value) of the lateral positional indicators for a cluster indicate direction of the cluster from the center line vector 402, and the absolute value of the statistical measure (e.g., mean d-value) provides a lateral indicator of distance of the cluster from the center line vector 402 (measured at a direction orthogonally to, or substantially orthogonally to, the flow of traffic).

Although the statistical measure of a lateral positional indicator of a cluster may be frequently referenced herein as the mean d-value and/or standard deviation of the d-value of the cluster, it will be appreciated that other statistical measures, such as median, may be used. While reference to a center line vector 402 and d-values defined as a lateral offset from the center line vector 402 are made herein, it will be appreciated that other methods for determining a baseline vector and/or corresponding lateral positional indicators of probes may be contemplated.

The clustering and determination of statistical lateral positional indicators may be determined using a variety of historical probe data. For example, in certain embodiments, all historical probe data available for a segment may be utilized to determine clusters and statistical measures of the historical positional indicators for the segment. As another example, a subset of probe data, such as data spanning a 1-month period may be used. In any event, the clustering and determination of statistical lateral positional indicators of historical probe data estimate a baseline for the lateral distribution of traffic over a segment. Operations 300 and 302 may occur separately from the other operations of FIG. 3. In this regard, the historical probe data may be processed, and associated lateral positional indicators may be stored on database 10, for access by lane status determination apparatus 10 and to be processed by example embodiments as described below.

In operation 310, apparatus 20 may include means, such as processing circuitry 22, memory 24, communication interface 26, and/or the like, for receiving subject probe data associated with a segment. The segment for which subject probe data is to be obtained may be indicated in a systematic manner, such that the process described below may be performed for a variety of segments on a routine basis and transmitted to user equipment 12 such as user equipment in the vicinity of, or approaching the segment. As another example, a vehicle and/or associated user or in-vehicle navigation system may be registered with a service to receive lane statuses such that as the vehicle approaches a segment, a request is initiated, and example embodiments determine lane statuses of the segment in response thereto, as described in further detail below.

In any event, the subject probe data for the segment may be considered a set of real-time, near real-time, or current probe data such as probe data spanning a time period leading up to a current time. For example, the subject probe data may include most recent probe data spanning the past hour, past day, and/or any other time period leading up to a certain time, such as a current or real time. When the subject probe data is received and processed systematically, the subject probe data analyzed may cover the time period since a most recent processing. For example, the subject probe data may span a 24-hour period and may be retrieved daily for processing. As another example, the subject probe data may span a 30-minute period and may be processed every 30 minutes.

At operation 312, apparatus 20 includes means, such as processing circuitry 22, memory 24, communication interface 26, and/or the like, for accessing the historical probe data associated with the segment. In this regard, a set of historical probe data processed with regard to operations 300 and 302, and pertaining to the same segment as the subject probe data may be accessed, such as on database 10. In certain embodiments, apparatus 20 may utilize all historical probe data available for a segment. In certain embodiments, apparatus 20 may select or retrieve only a subset of the historical probe data available, and in certain embodiments the subset of the historical probe data selected may be dependent on the subject probe data, and/or time relative to the week, or day of the week with which the subject probe data is associated. For example, if the subject probe data received with respect to operation 310 relates to a 4-hour window on a Saturday, example embodiments may access historical probe data associated with the same 4-hour window on Saturdays, on a given week or weeks prior to a time the subject probe data is received and/or processed. As another example, if the subject probe data is associated with a Friday, example embodiment may retrieve historical probe data associated with Fridays (optionally covering any extended time period). Any variation may be contemplated based on identified predictors of traffic. For example, certain timeframes on weekdays may be associated together as having similar traffic patterns.

In operation 314, apparatus 20 includes means, such as processing circuitry 22, memory 24, and/or the like, for partitioning the subject probe data into a same number of clusters as the historical probe data associated with the segment. In this regard, a similar or same algorithm such as used in operation 300 may be applied to the subject probe data (e.g., real-time, near real-time, or current probe data). For example, the k-means algorithm using the same k-value as used in operation 300 for processing historical probe data associated with the same segment may be used.

In operation 316, apparatus 20 includes means, such as processing circuitry 22, memory 24, and/or the like, for comparing a statistical measure of the subject lateral positional indicators to respective statistical measures of the historical lateral positional indicators. In this regard, example embodiments, such as processing circuitry 22 of apparatus 20 may calculate, for each cluster, a same statistical measure as was calculated for the historical probe data. For example, processing circuitry 22 may calculate the statistical measure of the subject lateral positional indicators as the mean d-value for each cluster of the subject probe data, similarly as described with respect to operation 302. It will be appreciated that the d-values of the subject lateral positional indicators should be calculated based on the same center line vector 402 used as the basis for calculating d-values of the historical probe data.

In operation, 318, apparatus 20 includes means, such as processing circuitry 22, memory 24, and/or the like, for determining whether any lane of the segment is closed dependent upon the comparison of the statistical measure of the subject lateral positional indicators to the respective statistical measure of the historical lateral positional indicators.

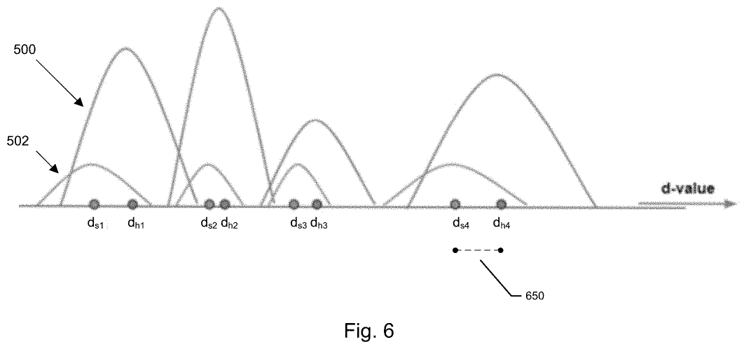

FIGS. 5 and 6 illustrate examples of comparisons of statistical measures of the subject lateral positional indicators to respective statistical measures of the historical lateral positional indicators. In FIGS. 5 and 6, four clusters of historical probe data 500, and four clusters of subject probe data are provided on x-y axes plotting the frequency of the probes by their d-values, or lateral positional indicators. Each peak represents a cluster of data. The statistical measures of lateral positional indicators, such as mean d-values, are indicated as dₛ₁, dₛ₂, dₛ₃, and dₛ₄ for the subject probe data, and dₕ₁, dₕ₂, dₕ₃, and dₕ₄ for the historical probe data.

In this regard, the statistical measures (e.g., mean) of the historical lateral positional indicators may be sorted, if not already, and the statistical measures (e.g., mean) of the historical lateral positional indicators may be sorted, if not already, so each statistical measure of the subject lateral positional indicator can be compared to a statistical measures of the historical lateral positional indicators of the respective cluster.

If the absolute value of an offset (e.g., difference) between any pair of historical and subject lateral positional indicators (e.g., dₕ₁ and dₛ₁, dₕ₂ and dₛ₂, etc.) equals or exceeds a closure threshold, example embodiments, such as processing circuitry 22, may determine at least one lane of the segment is closed. Example embodiments, such as processing circuitry 22 may determine a closure threshold as a predefined number, such as 2. The closure threshold (and/or shift threshold) may be selected, configured, and/or modified as described in further detail below.

For example, apparatus 20, such as processing circuitry 22, may use the following lane closure metric, LC-metric, to determine if there is a lane closure:

$$LC \text{-} metric = \frac{{\sum }_{l = 1}^{K} \vert {Lh}_{- mea n} - Lr\_mean \vert / Lh\_std}{K} ,$$

where Lh_mean is the statistical measure of the historic lateral positional indicator (e.g., mean d-value of a cluster of historical probe data), and Lr_mean is a statistical measure of the respective subject lateral positional indicator for the cluster (e.g., mean d-value of current, real-time, or near real-time probe data). Lh_std is the standard deviation of the historical lateral positional indicators (e.g., standard deviation of d-values of the cluster of historical probe data). If the resultant LC-metric for any cluster is greater than, or greater than or equal to, the closure threshold (e.g., 2), example embodiments determine at least one lane is closed.

In operation, 320, apparatus 20 includes means, such as processing circuitry 22, memory 24, and/or the like, for determining whether any lane of the segment is shifted dependent upon the comparison of the statistical measure of the subject lateral positional indicators to the respective statistical measure of the historical lateral positional indicators.

In this regard, in certain embodiments, a shift threshold may be defined. If the absolute value of an offset (e.g., difference) between any pair of historical and subject lateral positional indicators (e.g., dₕ₁ and dₛ₁, dₕ₂ and dₛ₂, etc.) is greater than, or is greater than or equal to a shift threshold, example embodiments, such as processing circuitry 22, may determine at least one lane is shifted.

If both a shift threshold and closure threshold are defined, such that both operations 318 and 320 may be performed, the shift threshold is lower than the closure threshold. In this regard, the offset between a pair of statistical measures of lateral indicators may not be high enough to determine a lane closure, but may be high enough to determine the shifting of a lane. A shift threshold may be defined as a predefined number, such as 1.7. The shift threshold may be selected, configured, and/or modified as described in further detail below.

For example, the offset 550 of FIG. 5 may satisfy a closure threshold, such that example embodiments, such as processing circuitry 22, determine at least one lane is closed. The offset 650 of FIG. 6 is less than the offset 550 of FIG. 5. In this regard, even if a closure threshold is not satisfied by the offset 650 (or if a closure threshold is not implemented or defined, and/or operation 318 is not performed), offset 650 may be indicative of a lane shift.

Accordingly, in certain embodiments, the processing of probe data to determine whether a lane is shifted, may only be performed if it is determined the same probe data is not indicative of a lane closure. In this regard, if the offset described above is substantial enough to indicate a lane closure, example embodiments may not necessarily perform additional analysis to determine lane shifting.

Still further, certain embodiments may be implemented to determine any of a lane closure or shifting, but not necessarily which one of the lane closure or shifting. Accordingly, various implementations may be considered.

The closure threshold and/or shift threshold may be modified and/or configured by a data scientist, programmer, or administrator to utilize a closure threshold and/or shift threshold that is likely to return accurate results. For example, the data scientist, programmer, or administrator may perform tests on certain data sets and compare known results as provided by users of other systems or other means of confirming or verifying results such as with cameras and/or other sensor data. The closure threshold and/or shift threshold may be fine-tuned and/or configured accordingly, and example embodiments may be deployed to perform the operations described herein on any data sets or segments for which probe data is available, regardless of availability of other infrastructure such as cameras, remote sensing systems, and/or the like.

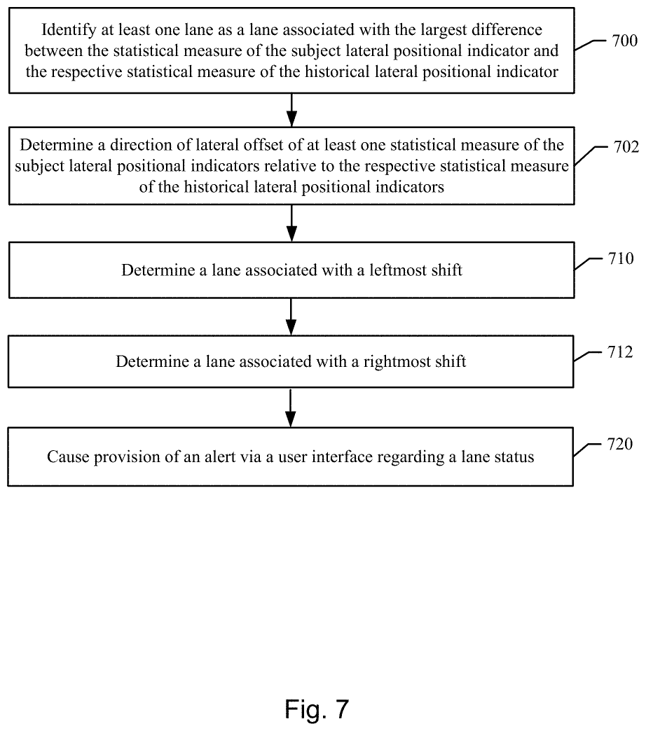

FIG. 7 is a flowchart of optional operations that may be performed according to example embodiments. In an instance at least one lane of the segment is determined as closed and/or shifted, in operation 700 apparatus 20 may include means, such as processing circuitry 22, memory 24, and/or the like, for identifying a lane associated with the largest difference between the statistical measure of the subject lateral positional indicator and the respective statistical measure of the historical lateral positional indicator. In this regard, the following equation can be used to identify which cluster (e.g., leftmost or rightmost) has the biggest lane shift (BLS) and is therefore identified as being associated with the lane that is likely closed or shifted:

$$BLS \text{-} metric = \frac{max \vert {Lh}_{- mea n} - Lr\_mean \vert}{Lh\_std} ,$$

where Lh_mean is the statistical measure of the historic lateral positional indicator (e.g., mean d-value of a cluster of historical probe data), and Lr_mean is a statistical measure of the respective subject lateral positional indicator for the cluster (e.g., mean d-value of current, real-time, or near real-time probe data). Lh_std is the standard deviation of the historic lateral positional indicators for the cluster std (e.g., standard deviation of d-values of the cluster of historical probe data). Accordingly, the cluster indicating the largest shift may be identified as associated with the closed lane, or the lane that is shifted. Example embodiments may rank differences between at least one statistical measure of the subject lateral positional indicator and the respective statistical measures of the historical lateral positional indicator to identify the maximum or largest difference, and therefore the lane most closely associated with the cluster that has the largest shift is most likely to be closed. For example, if a leftmost cluster is determined as having the largest shift, the leftmost lane may be determined to have the biggest shift.

In operation 702, in an instance it is determined at least one lane of the segment is determined as closed and/or shifted, apparatus 20 may include means, such as processing circuitry 22, memory 24, and/or the like, for determining a direction of lateral offset of at least one statistical measure of the subject lateral positional indicators relative to the respective statistical measure of the historical lateral positional indicators. The direction of the lateral offset may be determined as a direction (e.g., left or right) relative to the center line vector 402. A lane shift metric LS-metric such as follows may be used to determine a direction of the traffic shift (and therefore whether a rightmost or leftmost lane is closed), relative to the center line vector:

$$LS \text{-} metric = \frac{{\sum }_{l = 1}^{K} \vert {Lh}_{- mea n} - Lr\_mean \vert / Lh\_std}{K} .$$

Using the equation, if the resultant LS-metric is less than 0, example embodiments determine a shift of the respective cluster to the right, or a lane being closed such that the traffic associated with the respective cluster is shifted to the right. For example, if the resultant LS-metric is less than 0, and example embodiments have determined a lane closure, example embodiments may determine the leftmost lane is closed. As another example, if the resultant LS-metric is greater than 0, and example embodiments have determined a lane is shifted, example embodiments may determine the leftmost lane is shifted such that traffic is directed further to the right.

Using the above equation, if the resultant LS-metric is greater than 0, example embodiments determine a lane shift to the left, or lanes being closed such that the flow of traffic is shifted to the left. For example, if the resultant LS-metric is greater than 0, and example embodiments have determined a lane closure, example embodiments may determine the rightmost lane is closed. As another example, if the resultant LS-metric is greater than 0, and example embodiments have determined a lane is shifted, example embodiments may determine the rightmost lane is shifted such that traffic is directed further to the left.

As another example of operation 702, an equation may be used that determines the offset of the statistical measure of the historical lateral positional indicators from the statistical measure of the statistical measure of the subject lateral positional indicators (e.g., reverses the references to Lh_mean and Lr_mean) in comparison to the LS-metric equation provided above, such as

$$LS \text{-} metric = \frac{{\sum }_{l = 1}^{K} \vert {Lr}_{- mea n} - Lh\_mean \vert / Lh\_std}{K} ) .$$

In such an example, if the resultant LS-metric is less than 0, example embodiments determine a lane shift to the left, or lanes being closed such that the flow of traffic is shifted to the left. If the resultant LS-metric is greater than 0, and example embodiments have determined a lane is shifted, example embodiments may determine the rightmost lane is shifted such that traffic is directed further to the right.

In operation 710, apparatus 20 may include means, such as processing circuitry 22, memory 24, and/or the like, for determining a lane associated with a leftmost shift. Each cluster may be evaluated to determine one of an offset or difference of a subject lateral positional indicator from the respective historical lateral positional indicator of the associated cluster, or an offset or difference of a historical lateral positional indicator from the respective subject lateral positional indicator. If offsets or differences of subject lateral positional indicators from the respective historical lateral positional indicator of the associated cluster are analyzed, and the cluster returning the maximum difference is greater than 0, example embodiments may determine the cluster having the maximum difference is associated with the lane having a leftmost lane shift. For example, the following leftmost lane shift metric, LLS-metric, indicates the cluster having the leftmost lane shift:

$$LLS \text{-} metric = \frac{max ( L {h}_{- mean} - Lr\_mean )}{Lh\_std} .$$

If offsets or differences of a historical lateral positional indicators from the respective subject lateral positional indicator are analyzed, and the cluster having the minimum difference is less than 0, example embodiments may determine the cluster having the minimum difference is associated with the lane having a leftmost lane shift. For example, the following LLS-metric may also be considered:

$$LLS \text{-} metric = \frac{max ( {Lr}_{- mean} - Lh\_mean )}{Lh\_std} .$$

In operation 712, apparatus 20 may include means, such as processing circuitry 22, memory 24, and/or the like, for determining a lane associated with a rightmost shift. Each cluster may be evaluated to determine one of an offset or difference of a subject lateral positional indicator from the respective historical lateral positional indicator of the associated cluster, or an offset or difference of a historical lateral positional indicator from the respective subject lateral positional indicator. If offsets or differences of subject lateral positional indicators from the respective historical lateral positional indicator of the associated cluster are analyzed, and the cluster returning the minimum difference is less than 0, example embodiments may determine the cluster having the minimum difference is associated with the lane having a rightmost lane shift. For example, the metric below indicates the cluster having the rightmost lane shift

$$RLS \text{-} metric = \frac{min ( {Lh}_{- mean} - Lr\_mean )}{Lh\_std} .$$

If offsets or differences of a historical lateral positional indicators from the respective subject lateral positional indicator are analyzed, and the cluster having the maximum difference is greater than 0, example embodiments may determine the cluster having the maximum difference is associated with the lane having a rightmost lane shift. For example, the following RLS-metric may also be considered:

$$RLS \text{-} metric = \frac{max ( {Lr}_{- mean} - Lh\_mean )}{Lh\_std} .$$

As shown in operation 720, apparatus 20 may include means, such as processing circuitry 22, memory 24, communication interface 26, user interface 28, and/or the like, for causing provision of an alert via a user interface regarding a lane status, such as but not limited to a closed and/or shifted lane. For example, a lane status determination apparatus 8 may transmit an indication of a lane status to user equipment 12. The lane status may include an indicator such as a lane being closed and/or shifted, and/or any other information relating to a lane closure, and/or shifting, determined according to example embodiments described herein. For example, a lane status may include a direction of lane shift or lateral offset, an indication of a lane associated with a leftmost and/or rightmost shift, an indication of a lane associated with the largest shift, and/or the like. In any event, a user interface 28 of user equipment 12 may then provide an alert, message, or indication to a user regarding the lane status(es). Accordingly, drivers approaching or in a segment determined as having a lane closure or lane shift may be alerted and provided the relevant lane status information.

In certain embodiments, a confidence indicator associated with a determination of lane status, may be further determined, and the lane status may only be transmitted and/or provided to user equipment 28 if a certain confidence level is met, or confidence indicator criterion satisfied. Further detail regarding confidence indicators for lane-level predictions is provided in the U.S. patent application, titled, “METHOD, APPARATUS AND COMPUTER PROGRAM PRODUCT FOR DETERMINING LANE STATUS CONFIDENCE INDICATORS USING PROBE DATA,” and filed Dec. 9, 2020, which is hereby incorporated by reference in its entirety. However, in certain embodiments, any information determined regarding lane status as described herein may be provided via a user interface.

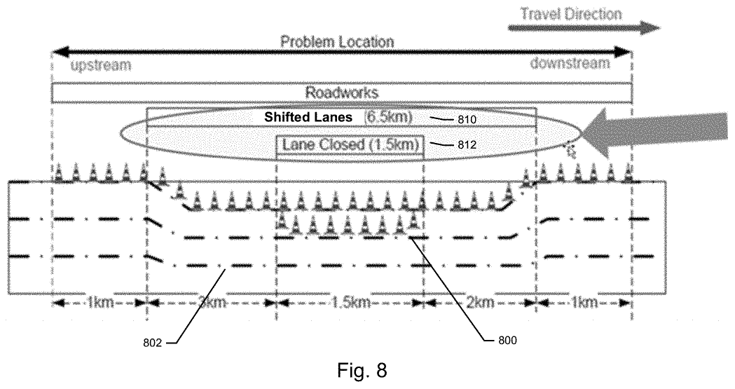

FIG. 8 is an example schematic that illustrates at least some benefits provided accordingly to certain example embodiments provided herein. Example embodiments may determine a segment(s), or series thereof, that includes a lane closure and/or shifting, as illustrated by the graphics 800, such as illustrated by indicators of cones or other barricades. For a segment in which a lane closure is detected, example embodiments may further detect which lane is closed (e.g., leftmost lane). The broken dashed lines 802 further illustrate the lane lines, which may be modified due to construction, for example. The label 810 indicates a segment for which a shifted lane is detected according to processing circuitry 22 of example embodiments. Label 812 indicates a segment for which a closed lane is detected by processing circuitry 22 of example embodiments. According to example embodiments, the exemplary lane statuses of FIG. 8 may be determined based on probe data and provided to drivers.

In addition to alerting a driver of any determined lane statuses described herein, the lane statuses may be used for any other means, such as making predictions regarding traffic speeds or backups, including future speeds or backups impacted by the determined lane statuses. For example, if example embodiments determine a lane closure, apparatus 20 may further predict related traffic problems or slowdowns such that drivers are re-routed, possibly prior to reaching the affected segment. Various applications and used of the determined lane statuses may be contemplated.

According to example embodiments provided herein, by using probe data, apparatus 20 may automatically determine real-time or near real-time lane statuses such as but not limited to closures and/or shifting. Example embodiments may be economically scalable across a vast array of geographic areas regardless of technological infrastructure, or independent of further infrastructure development, due to probe data being relatively inexpensive and widely available. Many telecommunications and information exchanges are currently deployed world-wide to enable the purchase of and/or access to probe data, such as those used to track general segment-level traffic volumes, speeds, or conditions.

Alternative attempts to determine lane statuses may rely on expensive technological infrastructure such as light detection and ranging (LIDAR) systems, other remote sensing systems and/or computer vision systems. In some cases, implementation of such equipment and systems on every segment for which lane status are desired may be unfeasible. In any event, example embodiments conserve processing and memory resources that would otherwise be expended to operate such equipment and systems, even if deployed, along segments for which lane statuses are desired.

Accordingly, as described herein, the method, apparatus 20 and computer program product of certain embodiments may leverage readily available probe data for a reasonable and feasible cost, and in a meaningful way, to determine lane statuses for drivers and/or other applications. Whereas raw GPS signals and/or probe data considered in isolation or in small quantities may not provide precise positional accuracy needed to make lane-level predictions, or may be too noisy to infer accurate lane-level predictions, utilizing historic probe data to establish baseline patterns of statistical measures, and comparing real-time or near real-time probe data thereto enables the method, apparatus 20 and computer program product of certain embodiments to determine lane statuses that are useful for drivers, traffic reporting applications, and/or the like. Example embodiments therefore provide an improvement to the use of probe data to provide a meaningful information in the form of detected lane-level closures and/or shifting.

FIGS. 3 and 7 illustrate flowcharts depicting a method according to an example embodiment of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus 20 employing an embodiment of the present invention and executed by the processing circuitry 22. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least processing circuitry and at least one non-transitory memory including computer program code instructions, the computer program code instructions configured to, when executed by the processing circuitry, cause the apparatus to:
partition subject probe data associated with at least one segment into a same number of clusters as historical probe data associated with the at least one segment, wherein the historical probe data is clustered based on respective lateral positional indicators;
for each cluster of the subject probe data, compare a statistical measure of the subject lateral positional indicators to respective statistical measures of the historical lateral positional indicators; and
determine whether any lane of the at least one segment is closed dependent upon the comparison of the statistical measure of the subject lateral positional indicators to the respective statistical measure of the historical lateral positional indicators.

2. The apparatus according to claim 1, wherein the computer program code instructions are further configured to, when executed by the processing circuitry, cause the apparatus to:
in an instance at least one statistical measure of the subject lateral positional indicator differs from the respective statistical measure of the historical lateral positional indicator by either of (a) at least a closure threshold, or (b) an amount greater than the closure threshold, determine that at least one lane of the at least one segment is closed.

3. The apparatus according to claim 1, wherein the computer program code instructions are further configured to, when executed by the processing circuitry, cause the apparatus to:
in an instance it is determined no lanes of the at least one segment are closed, determine whether at least one lane of the at least one segment is shifted.

4. The apparatus according to claim 1, wherein the computer program code instructions are further configured to, when executed by the processing circuitry, cause the apparatus to:
in an instance at least one lane of the at least one segment is determined as closed, determine a direction of lateral offset of at least one statistical measure of the subject lateral positional indicators relative to the respective statistical measure of the historical lateral positional indicators; and
identify at least one closed lane based upon the direction of the lateral offset.

5. The apparatus according to claim 1, wherein determining whether any lane of the at least one segment is closed is performed in real-time or near real-time relative to the receipt of the subject probe data.

6. The apparatus according to claim 1, wherein the subject probe data is associated with a time relative to a week or a day of the week, and the historical probe data is associated with the same time period relative to at least one prior week or at least one prior day of the week.

7. The apparatus according to claim 1, wherein the computer program code instructions are further configured to, when executed by the processing circuitry, cause the apparatus to:
perform a k-means algorithm on the historical probe data to partition the historical probe data and determine the clusters of the historical probe data; and
determine the respective statistical measures of the historical lateral positional indicators.

8. A computer program product comprising at least one non-transitory computer-readable storage medium having computer-executable program code instructions stored therein, the computer-executable program code instructions comprising program code instructions to:
partition subject probe data associated with at least one segment into a same number of clusters as historical probe data associated with the at least one segment, wherein the historical probe data is clustered based on respective lateral positional indicators;
for each cluster of the subject probe data, compare a statistical measure of the subject lateral positional indicators to respective statistical measures of the historical lateral positional indicators; and
determine whether any lane of the at least one segment is closed dependent upon the comparison of the statistical measure of the subject lateral positional indicators to the respective statistical measure of the historical lateral positional indicators.

9. The computer program product according to claim 8, wherein the computer-executable program code instructions further comprise program code instructions to:
in an instance at least one statistical measure of the subject lateral positional indicator differs from the respective statistical measure of the historical lateral positional indicator by either of (a) at least a closure threshold, or (b) an amount greater than the closure threshold, determine that at least one lane of the at least one segment is closed.

10. The computer program product according to claim 8, wherein the computer-executable program code instructions further comprise program code instructions to:
in an instance it is determined no lanes of the at least one segment are closed, determine whether at least one lane of the at least one segment is shifted.

11. The computer program product according to claim 8, wherein the computer-executable program code instructions further comprise program code instructions to:
in an instance at least one lane of the at least one segment is determined as closed, determine a direction of lateral offset of at least one statistical measure of the subject lateral positional indicators relative to the respective statistical measure of the historical lateral positional indicators; and
identify at least one closed lane based upon the direction of the lateral offset.

12. The computer program product according to claim 8, wherein determining whether any lane of the at least one segment is closed is performed in real-time or near real-time relative to the receipt of the subject probe data.

13. The computer program product according to claim 8, wherein the subject probe data is associated with a time relative to a week or a day of the week, and the historical probe data is associated with the same time period relative to at least one prior week or at least one prior day of the week.

14. The computer program product according to claim 8, wherein the computer-executable program code instructions further comprise program code instructions to:
perform a k-means algorithm on the historical probe data to partition the historical probe data and determine the clusters of the historical probe data; and
determine the respective statistical measures of the historical lateral positional indicators.

15. A method comprising:
partitioning subject probe data associated with at least one segment into a same number of clusters as historical probe data associated with the at least one segment, wherein the historical probe data is clustered based on respective lateral positional indicators;
for each cluster of the subject probe data, comparing a statistical measure of the subject lateral positional indicators to respective statistical measures of the historical lateral positional indicators; and
determining whether any lane of the at least one segment is closed dependent upon the comparison of the statistical measure of the subject lateral positional indicators to the respective statistical measure of the historical lateral positional indicators.

16. The method according to claim 15, further comprising:
in an instance at least one statistical measure of the subject lateral positional indicator differs from the respective statistical measure of the historical lateral positional indicator by either of (a) at least a closure threshold, or (b) an amount greater than the closure threshold, determining that at least one lane of the at least one segment is closed.

17. The method according to claim 15, further comprising:
in an instance it is determined no lanes of the at least one segment are closed, determining whether at least one lane of the at least one segment is shifted.

18. The method according to claim 15, further comprising:
in an instance at least one lane of the at least one segment is determined as closed, determining a direction of lateral offset of at least one statistical measure of the subject lateral positional indicators relative to the respective statistical measure of the historical lateral positional indicators; and
identifying at least one closed lane based upon the direction of the lateral offset.

19. The method according to claim 15, wherein determining whether any lane of the at least one segment is closed is performed in real-time or near real-time relative to the receipt of the subject probe data.

20. The method according to claim 15, wherein the subject probe data is associated with a time relative to a week or a day of the week, and the historical probe data is associated with the same time period relative to at least one prior week or at least one prior day of the week.

21. The method according to claim 15, further comprising:
performing a k-means algorithm on the historical probe data to partition the historical probe data and determine the clusters of the historical probe data; and
determining the respective statistical measures of the historical lateral positional indicators.
